(19) United States
(12) Patent Application Publication
(10) Pub. No.: US 2009/0110867 A1
(43) Pub. Date: Apr. 30, 2009

(54) Anti-skid exercise mat

(76) Inventor: Pao-Lan Feng Shen, Taichung County (TW)

Correspondence Address: BACON & THOMAS, PLLC, 625 SLATERS LANE, FOURTH FLOOR, ALEXANDRIA, VA, 22314-1176, US

(21) Appl. No.: 12/076,296

(22) Filed: Mar. 17, 2008

(30) Foreign Application Priority Data
Oct. 26, 2007 (TW) 96140166

(51) Int. Cl. B32B 3/26; B32B 3/00; B32B 7/12

(52) U.S. Cl. 428/71; 428/304.4; 428/317.1

(57) ABSTRACT

An anti-skid exercise mat includes a foam member having a predetermined thickness, a fabric layer located on at least one side of the foam member, and at least one soft plastic material disposed on a predetermined area of a surface of the fabric layer. Accordingly, the anti-skid exercise mat has preferable anti-skid and perspiration-absorptive functions during the whole course of exercising.

### BACKGROUND OF THE INVENTION

1. Field of the Invention

The present invention relates generally to exercise mats, and more particularly, to an anti-skid exercise mat.

2. Description of the Related Art

Generally speaking in the prior art, there are two kinds of conventional exercise mats mentioned below.

One of them includes a plastic or rubber foam member and a fabric layer adhered onto the foam member. A user can place this exercise mat on the floor and do exercise on the exercise mat. When the user sweats, the fabric layer provides absorption of perspiration and proper anti-skid function for the user's palms and body. The foam member also provides protection and buffer for the user. For example, Taiwan Patent Publication No. M251622 filed on Jan. 6, 2004 and published on Dec. 1, 2004 disclosed a typical exercise mat, which is an elongated mat having an air-permeable foam layer and a fabric mesh layer adhered onto the foam layer.

The other includes only one plastic or rubber foam member without the fabric layer adhered to the foam member, having a pure plastic or rubber surface. When the user does not sweat or sweats a little, it provides good anti-skid function for the user. For example, Taiwan Patent Publication No. M274136 published on Sep. 1, 2005 disclosed a typical exercise mat made of plastic foam.

The aforesaid exercise mats have some limited functions. For examples, a plastic or rubber foam member 10a shown in FIG. 1 or an exercise mat, whose surface is adhered with a plastic or rubber leather layer 12a, as shown in FIG. 2, provides good anti-skid function for the user's hands only when they do not sweat. When the user sweats, the surface of the plastic or rubber foam member 10a or the plastic or rubber leather layer 12a not only fails to provide good absorption of perspiration and good anti-skid function, but also even incurs sliding of the user's palms on the exercise mat. Another fabric layer 11a adhered to the surface of the foam member 10a, as shown in FIG. 3, is contrary to the aforesaid exercise mat in function. When the user's hands do not sweat or the user's palms are dry, there is no preferable resistance between the palms and the fabric layer, so that the palms tend to slide on the surface of the exercise mat. However, when the user's palms sweats or are wet, the exercise mat having the fabric layer 11a located on the surface thereof provides excellent absorption of perspiration and proper anti-skid function.

The user usually does not sweat on the palms while exercising in the beginning, such that the conventional exercise mat made of plastic or rubber foam 10a or of plastic or rubber leather layer 12a can provide good anti-skid function. However, when the user begins to sweat after exercising for a while, not only does the surface of such the conventional exercise mat fail to provide good absorption of perspiration and good anti-skid function, but also does the perspiration let the user feel uncomfortable. At this moment, the user needs the exercise mat having the fabric layer 11a located on the surface thereof to facilitate absorption of perspiration and to stop slipperiness. In other words, when the user's palms do not sweat, the user needs the exercise mat having the plastic or rubber foam member 10a or the plastic or rubber leather layer 12a to help stop slipperiness; when the palms begins to sweat, the user needs the exercise mat having the fabric layer 11a instead of the plastic or rubber foam member 10a or the plastic or rubber leather layer 12a to help absorption of perspiration and stop slipperiness. For this reason, it is very inconvenient for the user to switch one of the exercise mats to the other while exercising. Particularly, while doing yoga, the user often needs to put the palms on the exercise mat during the whole course of yoga. Therefore, the user looks forward to an improved exercise mat, which can stop slipperiness during the whole course no matter whether the palms sweat or not.

### SUMMARY OF THE INVENTION

The primary objective of the present invention is to provide an anti-skid exercise mat, which provides the user with the feeling of softness and comfortableness and with preferable absorption of perspiration and anti-skid function during the whole course of exercise.

The foregoing objective of the present invention is attained by the anti-skid exercise mat composed of a foam member having a predetermined thickness, a fabric layer located on at least one side of the foam member, and at least one soft plastic material disposed on a predetermined area of a surface of the fabric layer.

### BRIEF DESCRIPTION OF THE DRAWINGS

FIG. 1 is a perspective view of a conventional exercise mat having a foam member only.

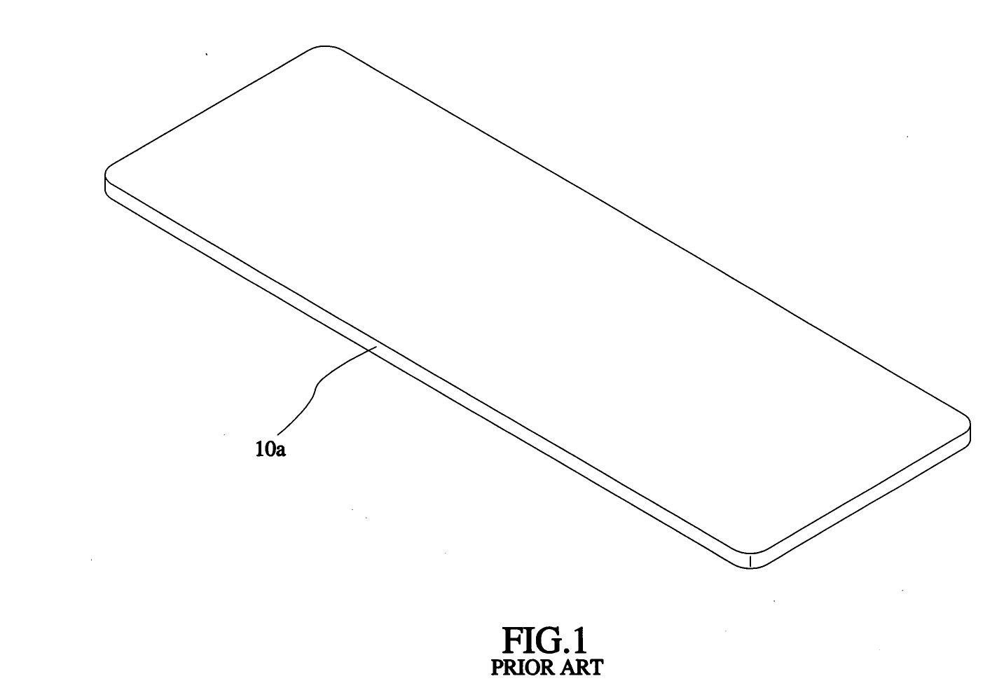

FIG. 2 is a perspective view of the conventional exercise mat having a foam member and a plastic or rubber leather layer located on a surface of the foam member.

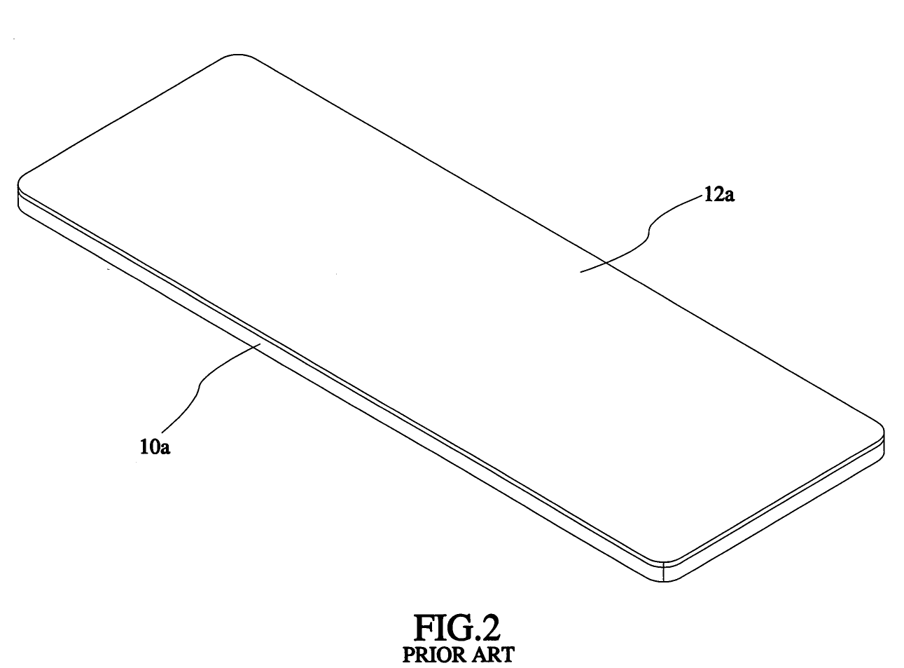

FIG. 3 is a perspective view of another conventional exercise mat having a foam member and a fabric layer located on the foam member.

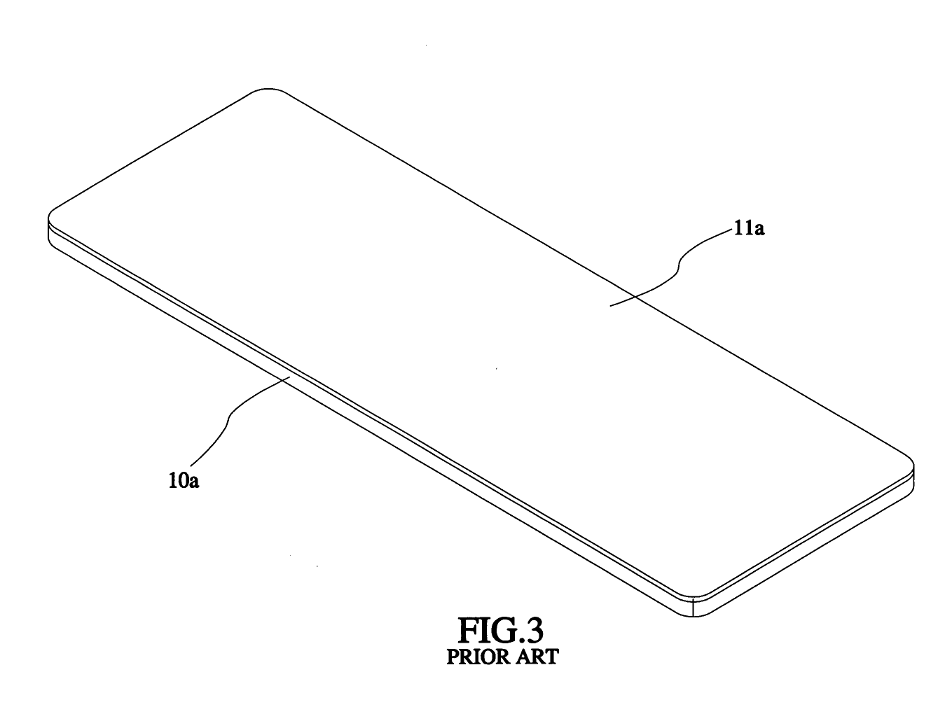

FIG. 4 is a perspective view of a first preferred embodiment of the present invention.

FIG. 5 is a perspective view of a part of the first preferred embodiment of the present invention.

FIG. 6 is another perspective view of the first preferred embodiment of the present invention, showing another arrangement of a soft plastic material.

FIG. 7 is another perspective view of a part of the first preferred embodiment of the present invention, showing that a fabric layer is attached to a foam member.

FIG. 8 is a perspective view of a part of a second embodiment of the present invention.

FIG. 9 is a sectional view of a part of the second embodiment of the present invention, showing that a soft plastic material is fixed onto a fabric layer.

FIG. 10 is similar to FIG. 9, showing that another soft plastic material is fixed onto the fabric layer.

FIG. 11 is a perspective view of the second embodiment of the present invention, showing a regular/irregular arrangement of the soft plastic material.

FIG. 12 is another perspective view of the second embodiment of the present invention, showing a regular arrangement of the soft plastic material.

### DETAILED DESCRIPTION OF PREFERRED EMBODIMENTS

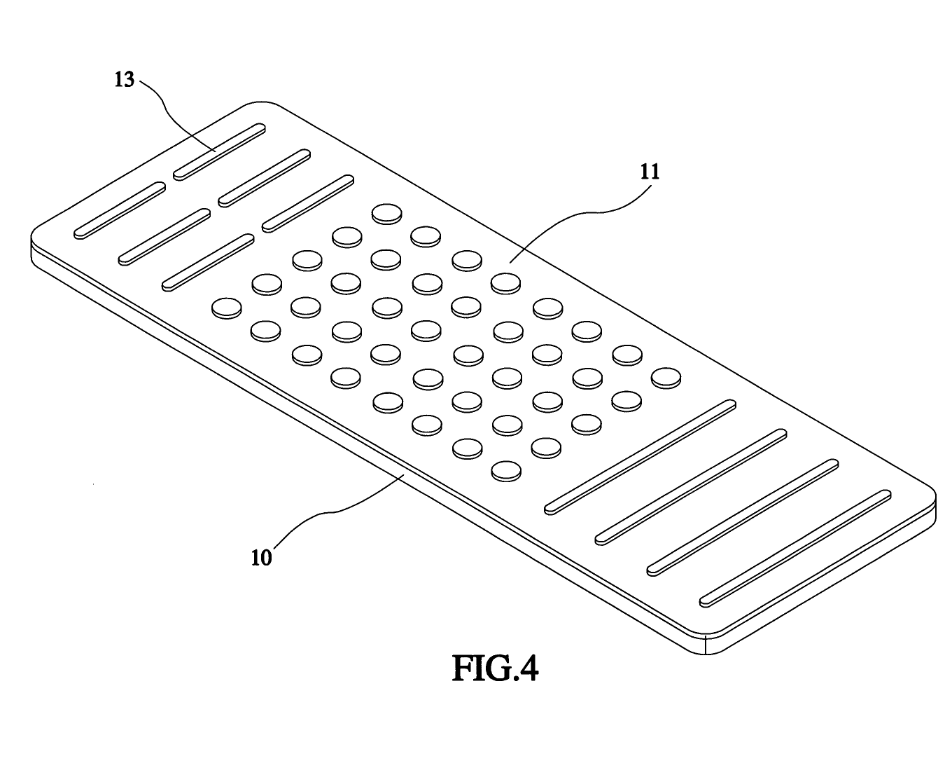

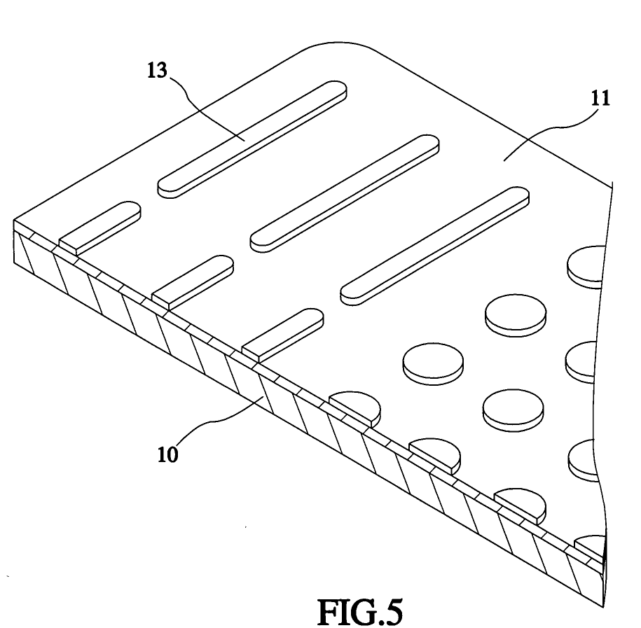

Referring to FIGS. 4-5, an anti-skid exercise mat constructed according to a first preferred embodiment of the present invention is composed of a foam member 10, a fabric layer 11, and a plurality of soft plastic materials 13.

The foam member 10 has a predetermined thickness.

The fabric layer 11 is attached to at least one side of the foam member 10.

The soft plastic materials 13 can be plastics or rubber and disposed onto a predetermined area of a surface of the fabric layer 11. In this embodiment, the soft plastic material 13 is adhesively fixed to the surface of the fabric layer 11. The soft plastic materials 13 each have a predetermined thickness of 0.01-0.7 cm, being strip-shaped and bossed.

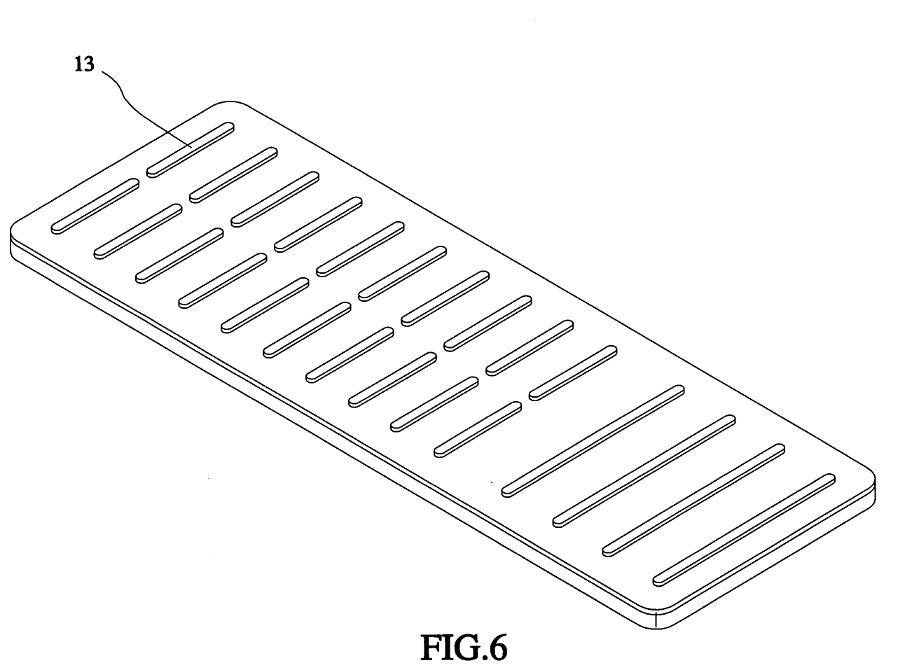

Referring to FIG. 6 illustrating another arrangement of the soft plastic materials 13, all of the soft plastic materials 13 are strip-shaped and disposed on the fabric layer 11.

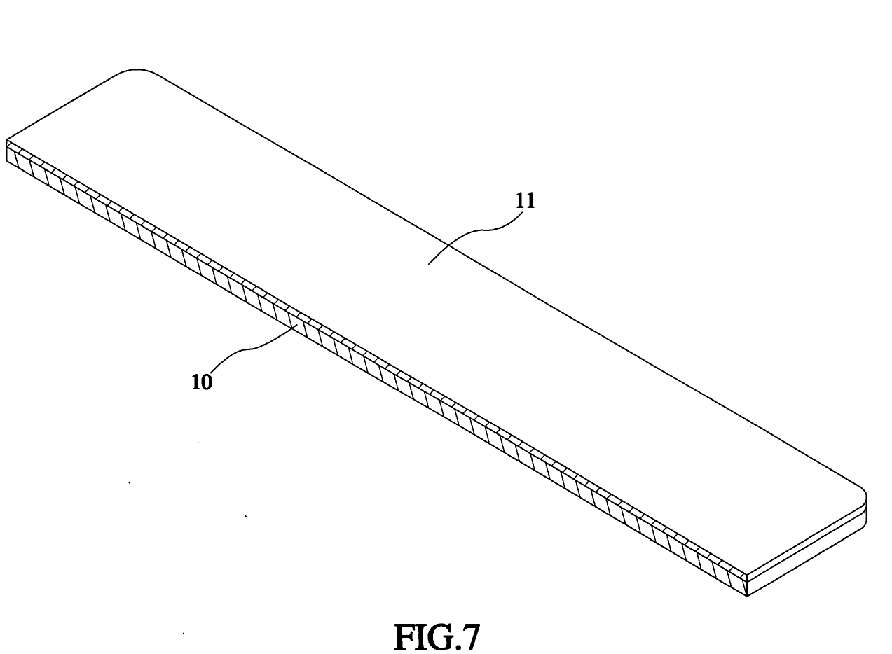

FIG. 7 illustrates that the fabric layer 11 is attached to the foam member 10.

In light of the above, the present invention includes the fabric layer 11 and the soft plastic materials 13 disposed on the surface thereof. When the user exercises on the exercise mat of the present invention, the exercise mat can absorb perspiration and stop slipperiness by the fabric layer 11, while the user's hands sweat, and stop slipperiness by the soft plastic materials 13, while the user's hands do not sweat, thus being anti-skid during the whole course of exercising.

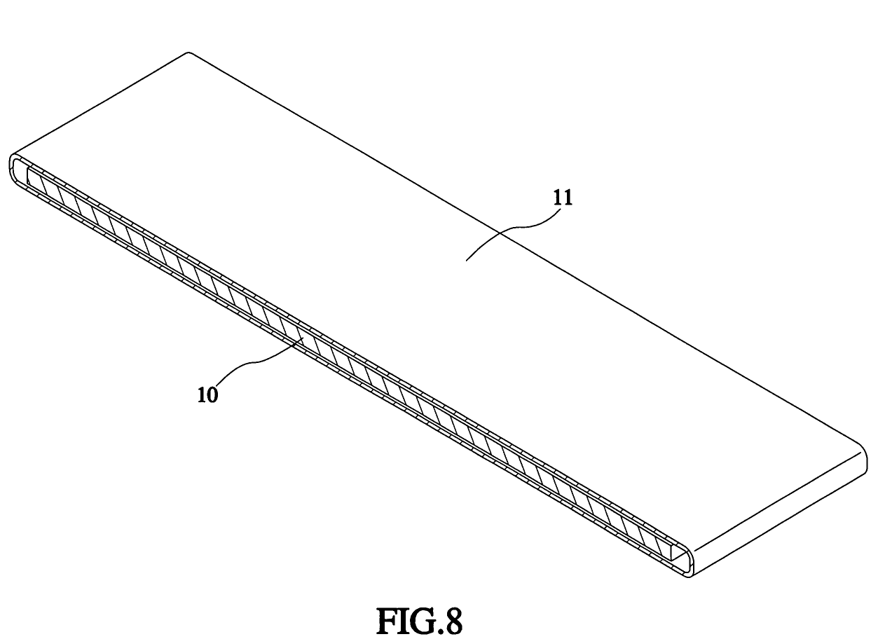

Referring to FIG. 8, an anti-skid exercise mat constructed according to a second preferred embodiment of the present invention is similar to the first embodiment, having the difference that the fabric layer 11 packages the foam member 10. The other features and effects of the second embodiment are the same as those of the first embodiment, such that no more recitation is necessary.

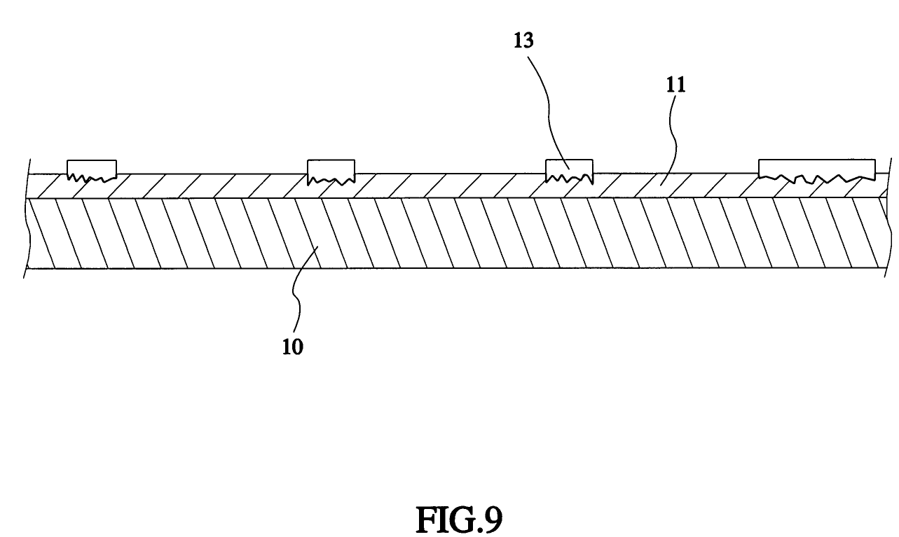

Referring to FIG. 9, the soft plastic materials 13 can be fixed to the fabric layer 11 in such an alternative way that bottom sides of the soft plastic materials 13 are dissolved by solvent to permeate the fabric layer 11 before the solvent is volatilized.

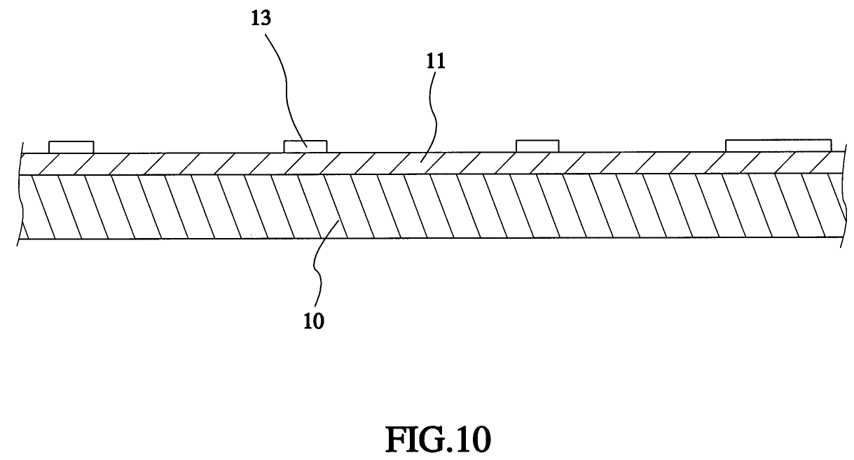

Referring to FIG. 10, the soft plastic materials 13 can be alternatively adhesively fixed to the fabric layer 11.

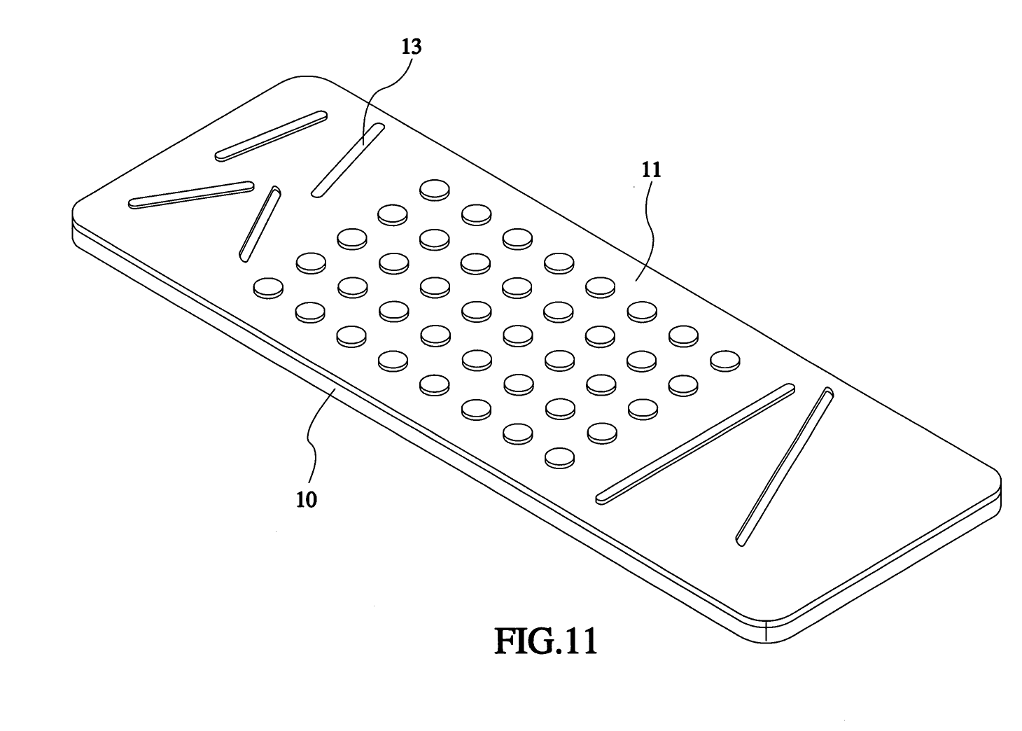

Referring to FIG. 11, the arrangement of the soft plastic materials 13 fixed to the fabric layer 11 can be alternatively regular and irregular.

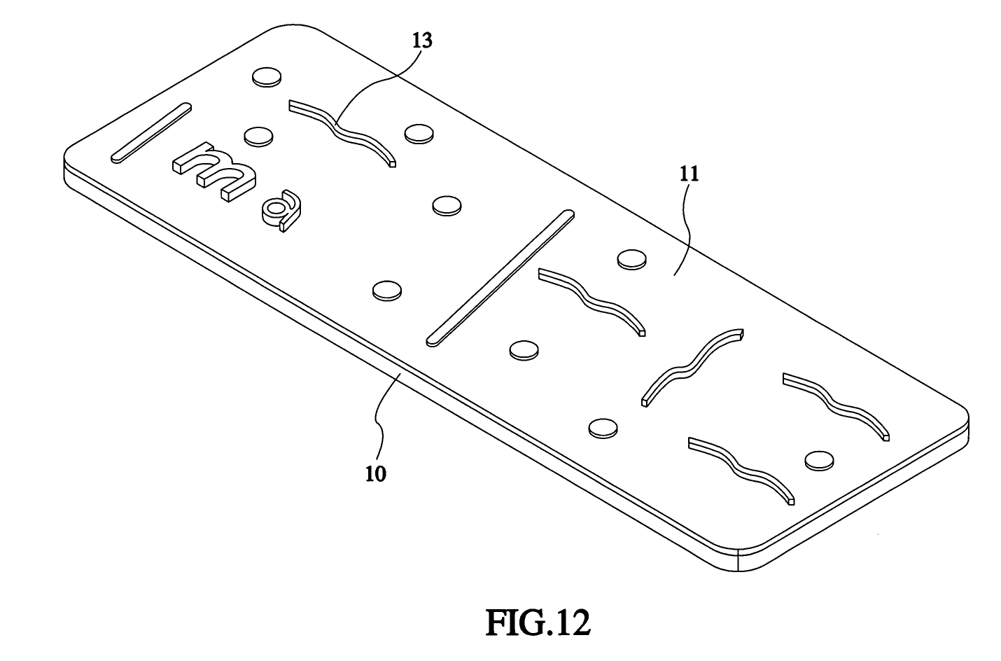

Referring to FIG. 12, the arrangement of the soft plastic materials 13 fixed to the fabric layer 11 can be alternatively irregular.

Although the present invention has been described with respect to specific preferred embodiments thereof, it is no way limited to the details of the illustrated structures but changes and modifications may be made within the scope of the appended claims.

What is claimed is:

1. An anti-skid exercise mat comprising:
a foam member having a predetermined thickness;
a fabric layer mounted to at least one side of said foam member; and
at least one soft plastic material disposed on a predetermined area of a surface of said fabric layer.

2. The anti-skid exercise mat as defined in claim 1, wherein said fabric layer is fixed to said foam member.

3. The anti-skid exercise mat as defined in claim 2, wherein said fabric layer is attached to said foam member.

4. The anti-skid exercise mat as defined in claim 1, wherein said fabric layer packages said foam member.

5. The anti-skid exercise mat as defined in claim 1, wherein said soft plastic material is adhesively fixed to a surface of said fabric layer.

6. The anti-skid exercise mat as defined in claim 1, wherein said at least one soft plastic material is plural in number.

7. The anti-skid exercise mat as defined in claim 6, wherein said soft plastic material is provided with a predetermined thickness.

8. The anti-skid exercise mat as defined in claim 7, wherein the thickness of said soft plastic material is 0.01-0.7 cm.

9. The anti-skid exercise mat as defined in claim 6, wherein said soft plastic materials are strip-shaped and regularly arranged on said fabric layer.

10. The anti-skid exercise mat as defined in claim 6, wherein said soft plastic materials are strip-shaped and irregularly arranged on said fabric layer.

11. The anti-skid exercise mat as defined in claim 6, wherein said soft plastic materials are bossed.
